(19) United States
(12) Patent Application Publication
(10) Pub. No.: US 2016/0065358 A1
(43) Pub. Date: Mar. 3, 2016

(54) SYNCHRONIZATION METHOD, INTERMEDIATE NODE, AND SLAVE NODE OF COMMUNICATION NETWORK SYSTEM

(71) Applicant: Huawei Technologies Co., Ltd., Shenzhen (CN)

(72) Inventors: Jinfang ZHANG, Shenzhen (CN); Bojie LI, Shenzhen (CN); Guodong ZHAO, Shenzhen (CN)

(21) Appl. No.: 14/934,768

(22) Filed: Nov. 6, 2015

Related U.S. Application Data
(63) Continuation of application No. PCT/CN2014/077167, filed on May 9, 2014.

(30) Foreign Application Priority Data
May 9, 2013 (CN) 201310169221.7

(51) Int. Cl. H04L 7/00; H04L 29/06

(52) U.S. Cl. CPC H04L 7/0012; H04L 69/22

(57) ABSTRACT

The present invention provides a synchronization method, an intermediate node, and a slave node. An intermediate node obtains, according to a local clock frequency of the intermediate node and an obtained clock frequency of a previous node, a frequency offset of the intermediate node relative to the previous node; the intermediate node obtains, according to the frequency offset of the intermediate node relative to the previous node and an obtained frequency offset of the previous node relative to a master clock, a frequency offset of the intermediate node relative to the master clock; the intermediate node transmits the frequency offset of the intermediate node relative to the master clock to a next node, so that a slave node corrects, according to the frequency offset of the intermediate node relative to the master clock, a clock frequency of the slave node or a clock frequency and time of the slave node.

### CROSS-REFERENCE TO RELATED APPLICATIONS

This application is a continuation of International Patent Application No. PCT/CN2014/077167, filed on May 9, 2014 which claims priority to Chinese Patent Application No. 201310169221.7, filed on May 9, 2013, both of which are hereby incorporated by reference in their entireties.

### TECHNICAL FIELD

The present invention relates to communication technologies and, in particular, to a synchronization method, an intermediate node and a salve node of a communication network system.

### BACKGROUND

In a communication system, if frequency and time are not synchronized, a communication system slip code may be incurred, thus, it requires strict frequency synchronization and time synchronization between nodes.

Currently, in an Ethernet, a 1588 protocol is used to perform frequency and time synchronization between nodes. According to the 1588 protocol, time stamp information is transmitted between a master node and a slave node by using data packets, each intermediate node obtains residence time according to the time stamp, and the slave node corrects a clock thereof to synchronize it with that of the master clock via a precision time protocol (Precision Time Protocol, PTP for short) algorithm. Moreover, the slave node obtains a frequency offset and corrects a frequency according to received time stamp information in a group of data packets and time stamp information obtained when receiving the group of data packets.

By means of using the above-described existing synchronization method, since the time stamp information in the data packets is determined according to a local clock frequency of each node, and acquisition of time according to the time stamp has a poor accuracy, thereby resulting in a low synchronization precision for the synchronization method.

### SUMMARY

A first aspect of the present invention provides a synchronization method of a communication network system, which is used to solve defects in the prior art and improve synchronization precision.

Another aspect of the present invention provides an intermediate node and a slave node of a communication network system, which are used to solve defects in the prior art and improve synchronization precision.

A first aspect of the present invention provides a synchronization method of a communication network system, including:

obtaining, by an intermediate node, according to a local clock frequency of the intermediate node and an obtained clock frequency of a previous node, a frequency offset of the intermediate node relative to the previous node;

obtaining, by the intermediate node, according to the frequency offset of the intermediate node relative to the previous node and an obtained frequency offset of the previous node relative to a master clock, a frequency offset of the intermediate node relative to the master clock; and

transmitting, by the intermediate node, the frequency offset of the intermediate node relative to the master clock to a next node, so that a slave node corrects a clock frequency of the slave node or a clock frequency and time of the slave node according to the frequency offset of the intermediate node relative to the master clock.

As the aspect and any possible implementation described above, an implementation is further provided, the obtaining, by the intermediate node, according to the local clock frequency of the intermediate node and the obtained clock frequency of the previous node, the frequency offset of the intermediate node relative to the previous node includes:

frequency mixing a signal having the local clock frequency with a generated signal having an auxiliary frequency to obtain a signal having a first mixed frequency;

obtaining a cycle count of the signal having the local clock frequency within one clock cycle of the signal having the first mixed frequency;

frequency mixing the signal having the clock frequency of the previous node with the signal having the auxiliary frequency to obtain a signal having a second mixed frequency;

obtaining a cycle count of the signal having the local clock frequency within one clock cycle of the signal having the second mixed frequency;

obtaining the frequency offset of the intermediate node relative to the previous node according to Δf(i)=(C₂−C₁)/(C₁C₂+C₁−C₂), where, i indicates a serial number of the intermediate node, Δf(i) indicates the frequency offset of the intermediate node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

As the aspect and any possible implementation described above, an implementation is further provided, the obtaining, by the intermediate node, according to the frequency offset of the intermediate node relative to the previous node and the obtained frequency offset of the previous node relative to the master clock, the frequency offset of the intermediate node relative to the master clock includes:

obtaining the frequency offset of the intermediate node relative to the master clock according to Δf_TC(i)=(1+Δf_TC(i−1))(1+Δf(i))−1, where, i indicates a serial number of the intermediate node, i−1 indicates a serial number of the previous node, Δf_TC(i) indicates the frequency offset of the intermediate node relative to the master clock, Δf_TC(i−1) indicates the frequency offset of the previous node relative to the master clock, and Δf(i) indicates the frequency offset of the intermediate node relative to the previous node.

As the aspect and any possible implementation described above, an implementation is further provided, the transmitting the frequency offset of the intermediate node relative to the master clock to the next node includes:

transmitting a 1588 data packet to the next node, where the frequency offset of the intermediate node relative to the master clock is carried in a reserved field of a packet header of the 1588 data packet;

or, transmitting a preset message employing a preset type length value TLV to the next node, where the frequency offset of the intermediate node relative to the master clock is carried in the preset message.

As the aspect and any possible implementation described above, an implementation is further provided, wherein after the obtaining the frequency offset of the intermediate node relative to the master clock, the method further includes:

obtaining, by the intermediate node, residence time of the 1588 data packet in the intermediate node according to time stamp information captured when receiving and transmitting the 1588 data packet;

correcting, by the intermediate node, the residence time of the 1588 data packet in the intermediate node by using the frequency offset of the intermediate node relative to the master clock; and

transmitting, by the intermediate node, the 1588 data packet to the next node after replacing cumulative residence time carried in the 1588 data packet with a sum of the cumulative residence time carried in the 1588 data packet plus the corrected residence time of the 1588 data packet in the intermediate node.

As the aspect and any possible implementation described above, an implementation is further provided, the correcting, by the intermediate node, the residence time of the 1588 data packet in the intermediate node by using the frequency offset of the intermediate node relative to the master clock includes:

correcting the residence time of the 1588 data packet in the intermediate node according to Δt_TC(i)=Δt(i)/(1+Δf_TC(i), where, i indicates a serial number of the intermediate node, Δt_TC(i) indicates the corrected residence timer of the 1588 data packet in the intermediate node, Δt(i) indicates the obtained residence time of the 1588 data packet in the intermediate node according to time stamp information captured when receiving and transmitting the 1588 data packet, and Δf_TC(i) indicates the frequency offset of the intermediate node relative to the master clock.

Another aspect of the present invention provides a synchronization method of a communication network system, including:

obtaining, by a slave node, according to a local clock frequency of the slave node and an obtained clock frequency of a previous node, a frequency offset of the slave node relative to the previous node;

obtaining, by the slave node, according to the frequency offset of the slave node relative to the previous node and an obtained frequency offset of the previous node relative to a master clock, a frequency offset of the slave node relative to the master clock; and

correcting, by the slave node, according to the frequency offset of the slave node relative to the master clock, the clock frequency of the slave node.

As the aspect and any possible implementation described above, an implementation is further provided, the obtaining, by the slave node, according to the local clock frequency of the slave node and the obtained clock frequency of the previous node, the frequency offset of the slave node relative to the previous node includes:

frequency mixing a signal having the local clock frequency with a generated signal having an auxiliary frequency to obtain a signal having a first mixed frequency;

obtaining a cycle count of the signal having the local clock frequency within one clock cycle of the signal having the first mixed frequency;

frequency mixing the signal having the clock frequency of the previous node with the signal having the auxiliary frequency to obtain a signal having a second mixed frequency;

obtaining a cycle count of the signal having the local clock frequency within a clock cycle of the signal having the second mixed frequency; and

obtaining the frequency offset of the slave node relative to the previous node according to Δf(s)=(C₂−C₁)/(C₁C₂+C₁−C₂), where, s indicates the slave node, Δf(s) indicates the frequency offset of the slave node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

As the aspect and any possible implementation described above, an implementation is further provided, the obtaining, according to the frequency offset of the slave node relative to the previous node and the obtained frequency offset of the previous node relative to the master clock, the frequency offset of the slave node relative to the master clock includes:

obtaining the frequency offset of the slave node relative to the master clock according to Δf_S(s)=(1+Δf_TC(i−1))(1+Δf(s))−1, where, s indicates the slave node, i−1 indicates a serial number of the previous node, Δf_S(s) indicates the frequency offset of the slave node relative to the master clock, Δf_TC(i−1) indicates the frequency offset of the previous node relative to the master clock, and Δf(s) indicates the frequency offset of the slave node relative to the previous node.

As the aspect and any possible implementation described above, an implementation is further provided, after the obtaining the frequency offset of the slave node relative to the master clock, the method further includes:

correcting, by the slave node, time of the slave node according to time stamp information captured when receiving and transmitting a 1588 data packet and cumulative residence time carried in the 1588 data packet.

Still another aspect of the present invention provides a synchronization apparatus of an intermediate node of a communication network system, including:

a first measuring unit, configured to obtain, according to a local clock frequency of the intermediate node and an obtained clock frequency of a previous node, a frequency offset of the intermediate node relative to the previous node;

a second measuring unit, configured to obtain, according to the frequency offset of the intermediate node relative to the previous node and an obtained frequency offset of the previous node relative to a master clock, a frequency offset of the intermediate node relative to the master clock; and

a transmitting unit, configured to transmit the frequency offset of the intermediate node relative to the master clock to a next node, so that a slave node corrects a clock frequency of the slave node or a clock frequency and time of the slave node according to the frequency offset of the intermediate node relative to the master clock.

As the aspect and any possible implementation described above, an implementation is further provided, the first measuring unit specifically includes:

a first frequency mixing subunit, configured to frequency mix a signal having the local clock frequency of the current node with a generated signal having an auxiliary frequency to obtain a signal having a first mixed frequency;

a first counter subunit, configured to obtain a cycle count of the signal having the local clock frequency within one clock cycle of the signal having the first mixed frequency;

a second frequency mixing subunit, configured to frequency mix the signal having the clock frequency of the previous node with the signal having the auxiliary frequency to obtain a signal having a second mixed frequency;

a second counter subunit, configured to obtain a cycle count of the signal having the local clock frequency within one clock cycle of the signal having the second mixed frequency; and

an acquiring subunit, configured to obtain the frequency offset of the intermediate node relative to the previous node according to Δf(i)=(C₂−C₁)/(C₁C₂+C₁−C₂), where, i indicates a serial number of the intermediate node, Δf(i) indicates the frequency offset of the intermediate node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

As the aspect and any possible implementation described above, an implementation is further provided,

the second measuring unit is specifically configured to obtain the frequency offset of the intermediate node relative to the master clock according to Δf_TC(i)=(1+Δf_TC(i−1))(1+Δf/(i))−1, where, i indicates a serial number of the intermediate node, i−1 indicates a serial number of the previous node, Δf_TC(i) indicates the frequency offset of the intermediate node relative to the master clock, Δf_TC(i−1) indicates the frequency offset of the previous node relative to the master clock, and Δf(i) indicates the frequency offset of the intermediate node relative to the previous node.

As the aspect and any possible implementation described above, an implementation is further provided,

the transmitting unit is specifically configured to transmit a 1588 data packet to the next node, where the frequency offset of the intermediate node relative to the master clock is carried in a reserved field of a packet header of the 1588 data packet;

or, the transmitting unit is specifically configured to transmit a preset message employing a preset type length value TLV to the next node, where the frequency offset of the intermediate node relative to the master clock is carried in the preset message.

As the aspect and any possible implementation described above, an implementation is further provided, wherein the synchronization apparatus further comprises:

a residence time acquiring unit, configured to obtain residence time of the 1588 data packet in the intermediate node according to time stamp information captured when receiving and transmitting the 1588 data packet;

a residence time correcting unit, configured to correct the residence time of the 1588 data packet in the intermediate node by using the frequency offset of the intermediate node relative to the master clock; and

the transmitting unit is further configured to transmit the 1588 data packet to the next node after replacing cumulative residence time carried in the 1588 data packet with a sum of the cumulative residence time carried in the 1588 data packet plus the corrected residence time of the 1588 data packet in the intermediate node.

As the aspect and any possible implementation described above, an implementation is further provided,

the residence time correcting unit is specifically configured to correct the residence time of the 1588 data packet in the intermediate node according to Δf_TC(i)=Δt(i)/(1+Δf_TC(i)), where, i indicates a serial number of the intermediate node, Δt_TC(i) indicates the corrected residence timer of the 1588 data packet in the intermediate node, Δt(i) indicates the obtained residence time of the 1588 data packet in the intermediate node according to time stamp information captured when receiving and transmitting the 1588 data packet, and Δf_TC(i) indicates the frequency offset of the intermediate node relative to the master clock.

Still another aspect of the present invention provides a synchronization apparatus of a slave node of a communication network system, including:

a first measuring unit, configured to obtain, according to a local clock frequency of the slave node and an obtained clock frequency of a previous node, a frequency offset of the slave node relative to the previous node;

a second measuring unit, configured to obtain, according to the frequency offset of the slave node relative to the previous node and an obtained frequency offset of the previous node relative to a master clock, a frequency offset of the slave node relative to the master clock; and

a frequency correcting unit, configured to correct, according to the frequency offset of the slave node relative to the master clock, the clock frequency of the slave node.

As the aspect and any possible implementation described above, an implementation is further provided, wherein the first measuring unit specifically includes:

a first frequency mixing subunit, configured to frequency mix a signal having the local clock frequency with a generated signal having an auxiliary frequency to obtain a signal having a first mixed frequency;

a first counter subunit, configured to obtain a cycle count of the signal having the local clock frequency within one clock cycle of the signal having the first mixed frequency;

a second frequency mixing subunit, configured to frequency mix the signal having the clock frequency of the previous node with the signal having the auxiliary frequency to obtain a signal having a second mixed frequency;

a second counter subunit, configured to obtain a cycle count of the signal having the local clock frequency within one clock cycle of the signal having the second mixed frequency; and

an acquiring subunit, configured to obtain the frequency offset of the slave node relative to the previous node according to Δf(s)=(C₂−C₁)/(C₁C₂+C₁−C₂), where, s indicates the slave node, Δf(s) indicates the frequency offset of the slave node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

As the aspect and any possible implementation described above, an implementation is further provided,

the second measuring unit is specifically configured to obtain the frequency offset of the slave node relative to the master clock according to Δf_S(s)=(1+Δf_TC(i−1))(1+Δf(s))−1, where, s indicates the slave node, i−1 indicates a serial number of the previous node, Δf_S(s) indicates the frequency offset of the slave node relative to the master clock, Δf_TC(i−1) indicates the frequency offset of the previous node relative to the master clock, and Δf(s) indicates the frequency offset of the slave node relative to the previous node.

As the aspect and any possible implementation described above, an implementation is further provided, wherein the synchronization apparatus further includes:

a time correcting unit, configured to correct time of the slave node according to time stamp information captured when receiving and transmitting a 1588 data packet and cumulative residence time carried in the 1588 data packet.

Still another aspect of the present invention provides an intermediate node of a communication network system, including:

a first processor, configured to obtain, according to a local clock frequency of the intermediate node and an obtained clock frequency of a previous node, a frequency offset of the intermediate node relative to the previous node;

a second processor, configured to obtain, according to the frequency offset of the intermediate node relative to the previous node and an obtained frequency offset of the previous node relative to a master clock, a frequency offset of the intermediate node relative to the master clock;

a transmitter, configured to transmit the frequency offset of the intermediate node relative to the master clock to a next node, so that a slave node corrects a clock frequency of the slave node or a clock frequency and time of the slave node according to the frequency offset of the intermediate node relative to the master clock; and

a bus, configured to connect the first processor, the second processor and the transmitter, where a data interaction is performed among the first processor, the second processor and the transmitter via the bus.

The aspect and any possible implementation, an implementation is further provided, wherein the first processor specifically includes:

a first frequency mixer, configured to frequency mix a signal having the local clock frequency of the current node with a generated signal having an auxiliary frequency to obtain a signal having a first mixed frequency;

a first counter, configured to obtain a cycle count of the signal having the local clock frequency within one clock cycle of the signal having the first mixed frequency;

a second frequency mixer, configured to frequency mix the signal having the clock frequency of the previous node with the signal having the auxiliary frequency to obtain a signal having a second mixed frequency;

a second counter, configured to obtain a cycle count of the signal having the local clock frequency within one clock cycle of the signal having the second mixed frequency;

an arithmetic unit, configured to obtain the frequency offset of the intermediate node relative to the previous node according to Δf(i)=(C₂−C₁)/(C₁C₂+C₁−C₂), where, i indicates a serial number of the intermediate node, Δf(i) indicates the frequency offset of the intermediate node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

As the aspect and any possible implementation, an implementation is further provided,

the second processor is specifically configured to obtain the frequency offset of the intermediate node relative to the master clock according to Δf_TC(i)=(1+Δf_TC(i−1))(1+Δf/(i))−1, where, i indicates a serial number of the intermediate node, i−1 indicates a serial number of the previous node, Δf_TC(i) indicates the frequency offset of the intermediate node relative to the master clock, Δf_TC(i−1) indicates the frequency offset of the previous node relative to the master clock, and Δf(i) indicates the frequency offset of the intermediate node relative to the previous node.

As the aspect and any possible implementation described above, an implementation is further provided,

the transmitter is specifically configured to transmit a 1588 data packet to the next node, where the frequency offset of the intermediate node relative to the master clock is carried in a reserved field of a packet header of the 1588 data packet;

or, the transmitter is specifically configured to transmit a preset message employing a preset type length value TLV to the next node, where the frequency offset of the intermediate node relative to the master clock is carried in the preset message.

As the aspect and any possible implementation described above, an implementation is further provided, wherein the intermediate node further includes:

a fourth processor, configured to obtain residence time of the 1588 data packet in the intermediate node according to time stamp information captured when receiving and transmitting the 1588 data packet;

a fifth processor, configured to correct the residence time of the 1588 data packet in the intermediate node by using the frequency offset of the intermediate node relative to the master clock; and

the transmitter is further configured to transmit the 1588 data packet to the next node after replacing cumulative residence time carried in the 1588 data packet with a sum of the cumulative residence time carried in the 1588 data packet plus the corrected residence time of the 1588 data packet in the intermediate node.

As the aspect and any possible implementation described above, an implementation is further provided,

the fifth processor is specifically configured to correct the residence time of the 1588 data packet in the intermediate node according to Δt_TC(i)=Δt(i)/(1+Δf_TC(i)), where, i indicates a serial number of the intermediate node, Δt_TC(i) indicates the corrected residence timer of the 1588 data packet in the intermediate node, Δt(i) indicates the obtained residence time of the 1588 data packet in the intermediate node according to time stamp information captured when receiving and transmitting the 1588 data packet, and Δf_TC(i) indicates the frequency offset of the intermediate node relative to the master clock.

Still another aspect of the present invention provides a slave node of a communication network system, including:

a first processor, configured to obtain, according to a local clock frequency of the slave node and an obtained clock frequency of a previous node, a frequency offset of the slave node relative to the previous node;

a second processor, configured to obtain, according to the frequency offset of the slave node relative to the previous node and an obtained frequency offset of the previous node relative to a master clock, a frequency offset of the slave node relative to the master clock; and

a third processor, configured to correct, according to the frequency offset of the slave node relative to the master clock, the clock frequency of the slave node; and

a bus, configured to connect the first processor, the second processor and the third processor, where a data interaction is performed among the first processor, the second process and the third processor via the bus.

As the aspect and any possible implementation described above, an implementation is further provided, wherein the first processor specifically includes:

a first frequency mixer, configured to frequency mix a signal having the local clock frequency with a generated signal having an auxiliary frequency to obtain a signal having a first mixed frequency;

a first counter, configured to obtain a cycle count of the signal having the local clock frequency within one clock cycle of the signal having the first mixed frequency;

a second frequency mixer, configured to frequency mix the signal having the clock frequency of the previous node with the signal having the auxiliary frequency to obtain a signal having a second mixed frequency;

a second counter, configured to obtain a cycle count of the signal having the local clock frequency within one clock cycle of the signal having the second mixed frequency;

an arithmetic unit, configured to obtain the frequency offset of the slave node relative to the previous node according to Δf(s)=(C₂−C₁)/(C₁C₂+C₁−C₂), where, s indicates the slave node, Δf(s) indicates the frequency offset of the slave node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

As the aspect and any possible implementation described above, an implementation is further provided,

the second processor is specifically configured to obtain the frequency offset of the slave node relative to the master clock according to Δf_S(s)=(1+Δf_TC(i−1))(1+Δf(s))−1, where, s indicates the slave node, i−1 indicates a serial number of the previous node, Δf_S(s) indicates the frequency offset of the slave node relative to the master clock, Δf_TC(i−1) indicates the frequency offset of the previous node relative to the master clock, and Δf(s) indicates the frequency offset of the slave node relative to the previous node.

As the aspect and any possible implementation described above, an implementation is further provided, wherein the slave node further includes:

a fourth processor, configured to correct, time of the slave node according to time stamp information captured when receiving and transmitting a 1588 data packet and cumulative residence time carried in the 1588 data packet.

It can be seen from the summary of the invention that, a frequency offset of a current node relative to a previous node is obtained firstly according to a local clock frequency of the current node and an obtained clock frequency of the previous node, and then a frequency offset of the current node relative to a master clock is obtained according to the frequency offset of the current node relative to the previous node and an obtained frequency offset of the previous node relative to the master clock, so that a clock frequency of the current node can be corrected according to the frequency offset of the current node relative to the master clock. Since the frequency offset of the current node relative to the master clock is measured by means of generating an auxiliary frequency using a physical layer, thus the clock frequency of the current node may be corrected, and clock synchronization precision is improved.

### BRIEF DESCRIPTION OF DRAWINGS

In order to make technical solutions in embodiments of the present invention or the prior art clearer, accompanying drawings used for description of embodiments or the prior art will be briefly described hereunder. Obviously, the described drawings are merely some embodiments of present invention. For persons skilled in the art, other drawings may be obtained based on these drawings without any creative effort.

FIG. 1 is a flow chart of a synchronization method of a communication network system according to embodiment 1 of the present invention;

FIG. 2 is a flow chart of a synchronization method of a communication network system according to embodiment 2 of the present invention;

FIG. 3 is a flow chart of a synchronization method of a communication network system according to embodiment 3 of the present invention;

FIG. 4 is a schematic structural diagram of a synchronization apparatus of an intermediate node of a communication network system according to embodiment 4 of the present invention;

FIG. 5 is a schematic structural diagram of a synchronization apparatus of a slave node of a communication network system according to embodiment 5 of the present invention;

FIG. 6 is a schematic structural diagram of an intermediate node of a communication network system according to embodiment 6 of the present invention;

FIG. 7 is a schematic structural diagram of a slave node of a communication network system according to embodiment 7 of the present invention.

### DESCRIPTION OF EMBODIMENTS

Technical solutions in embodiments of the present invention will be described hereinafter clearly and completely with reference to drawings accompanying the embodiments of the present invention. Obviously, the described embodiments are only a part of embodiments of the present invention, rather than all embodiments thereof. All other embodiments obtained by persons of ordinary skill in the art based on embodiments of the present invention without any creative effort shall fall into the protection scope of the present invention.

FIG. 1 is a flow chart of a synchronization method of a communication network system according to embodiment 1 of the present invention. As shown in FIG. 1, the method includes the following procedures.

Step 101, an intermediate node obtains, according to a local clock frequency of the intermediate node and an obtained clock frequency of a previous node, a frequency offset of the intermediate node relative to the previous node.

Step 102, the intermediate node obtains, according to the frequency offset of the intermediate node relative to the previous node and an obtained frequency offset of the previous node relative to a master clock, a frequency offset of the intermediate node relative to the master clock.

Step 103, the intermediate node transmits the frequency offset of the intermediate node relative to the master clock to a next node.

In this step, the intermediate node transmits the frequency offset of the intermediate node relative to the master clock to a next node, so that a slave node corrects a clock frequency of the slave node or correct a clock frequency and time of the slave node according to the frequency offset of the intermediate node relative to the master clock.

In embodiment 1 of the present invention, an intermediate node firstly obtains, according to a local clock frequency of itself and an obtained a clock frequency of a previous node, a frequency offset of the intermediate node relative to the previous node, and then obtains, according to the frequency offset of the intermediate node relative to the previous node and an obtained frequency offset of the previous node relative to a master clock, a frequency offset of the intermediate node relative to the master clock, and transmits the frequency offset of the intermediate node relative to the master clock to a next node, so that a slave node can correct a clock frequency of the slave node or correct a clock frequency and time of the slave node according to the frequency offset of the intermediate node relative to the master clock. Since the frequency offset of the intermediate node relative to the master clock is measured, and a result is transmitted to the slave node, thus, the clock frequency may be corrected by the slave node, and clock synchronization precision is improved.

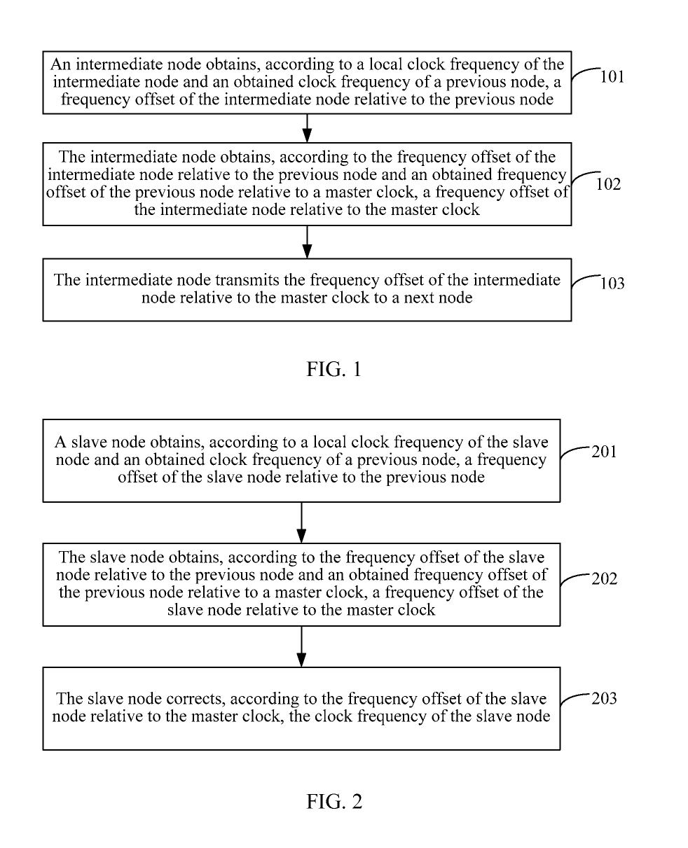

FIG. 2 is a flow chart of a synchronization method of a communication network system according to embodiment 2 of the present invention. As shown in FIG. 2, the method includes the following procedures.

Step 201, a slave node obtains, according to a local clock frequency of the slave node and an obtained clock frequency of a previous node, a frequency offset of the slave node relative to the previous node.

Step 202, the slave node obtains, according to the frequency offset of the slave node relative to the previous node and an obtained frequency offset of the previous node relative to a master clock, a frequency offset of the slave node relative to the master clock.

Step 203, the slave node corrects, according to the frequency offset of the slave node relative to the master clock, the clock frequency of the slave node.

In embodiment 2 of the present invention, a slave node firstly obtains, according to a local clock frequency of itself and an obtained a clock frequency of a previous node, a frequency offset of the slave node relative to the previous node, and then obtains, according to the frequency offset of the slave node relative to the previous node and an obtained frequency offset of the previous node relative to a master clock, a frequency offset of the slave node relative to the master clock, so that the clock frequency of the slave node can be corrected according to the frequency offset of the slave node relative to the master clock. Since the frequency offset of the slave node relative to the master clock is measured, thus, the clock frequency of the slave node may be corrected, and clock synchronization precision is improved.

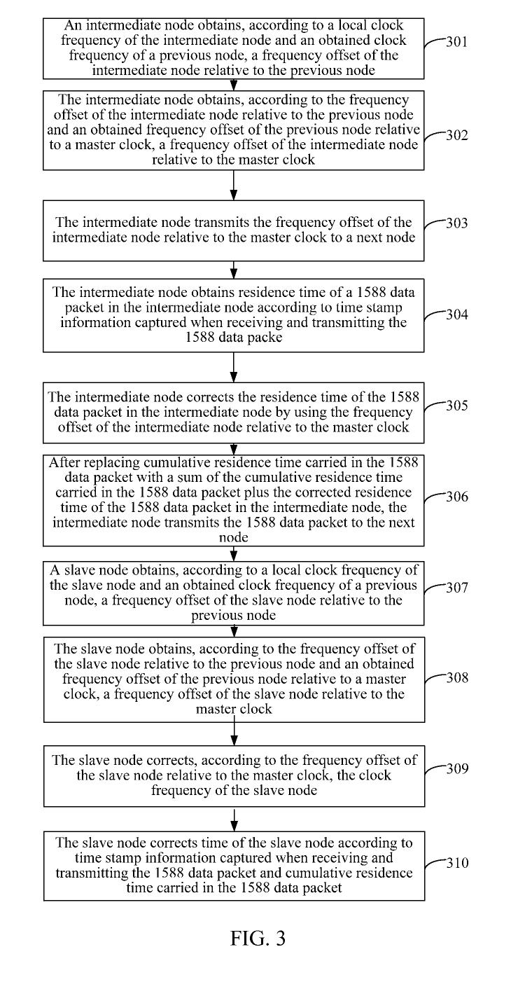

FIG. 3 is a flow chart of a synchronization method of a communication network system according to embodiment 3 of the present invention. As shown in FIG. 2, the method includes the following procedures.

Step 301, an intermediate node obtains, according to a local clock frequency of the intermediate node and an obtained clock frequency of a previous node, a frequency offset of the intermediate node relative to the previous node.

In this step, the intermediate node generates a signal having an auxiliary frequency, and obtains a frequency offset of the intermediate node relative to the previous node according to the local clock frequency of the intermediate node, the generated auxiliary frequency and the obtained clock frequency of the previous node. This step is implemented specifically using the following method.

Step 1, frequency mixing a signal having the local clock frequency of the intermediate node with the signal having the auxiliary frequency to obtain a signal having a first mixed frequency. f_{R} represents the local clock frequency of the current node, f₀ represents the generated auxiliary frequency, f₀−f_{R}×(1−½ⁿ), where n represents a positive integer greater than 0, and a value of n enables an offset of f₀ for a local clock frequency to be slightly greater than a frequency offset range allowed by Ethernet.

Step 2, obtaining a cycle count of the signal having the local clock frequency of the intermediate node within one clock cycle of the signal having the first mixed frequency. C₁ represents the count of the signal having the local clock frequency of the intermediate node within one clock cycle of the signal having the first mixed frequency, C₁=2ⁿ, where n represents a positive integer greater than 0, and a value of n enables an offset of f₀ for the local clock frequency to be slightly greater than a frequency offset range allowed by Ethernet.

Step 3, frequency mixing the signal having the clock frequency of the previous node with the signal having the auxiliary frequency to obtain a signal having a second mixed frequency. f_{T} represents the clock frequency of the previous node.

Step 4, obtaining a cycle count of the signal having the local clock frequency of the intermediate node within one clock cycle of the signal having the second mixed frequency. C₂ represents the cycle count of the signal having the local clock frequency of the intermediate node within one clock cycle of the signal having the second mixed frequency, C₂=f_{R}/(f_{T}−f_{R}×(1−1/C1)).

Step 5, obtaining the frequency offset of the intermediate node relative to the previous node according to Δf(i)=(C₂−C₁)/(C₁C₂+C₁−C₂), where, i indicates a serial number of the intermediate node, Δf(i) indicates the frequency offset of the intermediate node relative to the previous node, C₁ indicates the cycle count of the signal having the local clock frequency of the intermediate node within one clock cycle of the signal having the first mixed frequency, and C₂ indicates the cycle count of the signal having the local clock frequency of the intermediate node within one clock cycle of the signal having the second mixed frequency. Specifically, Δf(i)=(f_{R}−f_{T})/f_{T}=(C₂−C₁)/(C₁C₂+C₁−C₂).

The step 2 described above is performed after the step 1 is performed, the step 4 is performed after the step 3 is performed, the step 5 is performed after both the step 2 and the step 4 are performed, and the execution sequence is not limited between the step 1 as well as the step 2 and the step 3 as well as the step 4.

Moreover, after the step 1 and before the step 2, the first mixed frequency may also be subject to low-pass filtering, and in the step 2, the cycle count of the signal having the local clock frequency of the intermediate node within one clock cycle of the signal having the first mixed frequency after the low-pass filtering is obtained. After the step 3 and before the step 4, the second mixed frequency may also be subject to low-pass filtering, and in the step 4, the cycle count of the signal having the local clock frequency of the intermediate node within one clock cycle of the signal having the second mixed frequency after the low-pass filtering is obtained.

Step 302, the intermediate node obtains, according to the frequency offset of the intermediate node relative to the previous node and an obtained frequency offset of the previous node relative to a master clock, a frequency offset of the intermediate node relative to the master clock.

In this step, the frequency offset of the intermediate node relative to the master clock is obtained according to Δf_TC(i)=(1+Δf_TC(i−1))(1+Δf(i))−1, where, i indicates a serial number of the intermediate node, i−1 indicates a serial number of the previous node, Δf_TC(i) indicates the frequency offset of the intermediate node relative to the master clock, Δf_TC(i−1) indicates the frequency offset of the previous node relative to the master clock, and Δf(i) indicates the frequency offset of the intermediate node relative to the previous node. i−1 indicates a serial number of the previous node, and the previous node may be an intermediate node, and may also be a master clock node. If the previous node is the master clock node, Δf_TC(i−1)=0, Δf_TC(i)=Δf(i).

Step 303, the intermediate node transmits the frequency offset of the intermediate node relative to the master clock to a next node.

In this step, any one of the following two methods may be used specifically.

Method 1: transmitting a 1588 data packet to the next node, where the frequency offset of the intermediate node relative to the master clock is carried in a reserved field of a packet header of the 1588 data packet. Method 1 is used to transmit the frequency offset of the intermediate node relative to the master clock by utilizing a 4-byte field reserved in a packet header of an existing 1588 general data packet, which may be expressed as: (a frequency offset value×2ⁿ) ppb, and a measurement accuracy of 2⁻ⁿ ppb is obtained, where 0≦n<32. A length of the data packet is not increased additionally by using method 1, which will not affect the data packet to incur transmission delay.

Method 2, transmitting a preset message employing a preset type length value (type/length/value, TLV for short) to the next node, where the frequency offset of the intermediate node relative to the master clock is carried in the preset message. Method 2 is used to define a new TLV, which may be directly suffixed after an existing non-event message, or carried in a manufacturer customized message. According to a protocol, a data field (dataField) may customize a length N (such as 4˜8 bytes) to transmit the frequency offset, then the new TLV may be expressed as: (a frequency offset value×2ⁿ) ppb, and a measurement accuracy of 2⁻ⁿ ppb is obtained, where 0≦n<8N.

Step 304, the intermediate node obtains residence time of a 1588 data packet in the intermediate node according to time stamp information captured when receiving and transmitting the 1588 data packet.

In this step, a specific method for capturing time stamp information when receiving and transmitting a 1588 data packet is not limited; and any method that can capture the time stamp information is applicable. Moreover, a specific method for obtaining residence time according to the time stamp information is not limited; and any method that can obtain the residence time according to the time stamp information is applicable.

An execution sequence between the step 304 and the step 301˜step 303 is not limited. After both the step 302 and the step 304 are performed, the step 305 is performed.

Step 305, the intermediate node corrects the residence time of the 1588 data packet in the intermediate node by using the frequency offset of the intermediate node relative to the master clock.

In this step, the residence time of the 1588 data packet in the intermediate node is corrected according to Δt_TC(i)=Δt(i)/(1+Δf_TC(i)), where, i indicates a serial number of the intermediate node, Δt_TC(i) indicates the corrected residence timer of the 1588 data packet in the intermediate node, Δt(i) indicates the obtained residence time of the 1588 data packet in the intermediate node according to time stamp information captured when receiving and transmitting the 1588 data packet, and Δf_TC(i) indicates the frequency offset of the intermediate node relative to the master clock.

After the step 305, the step 306 is performed.

Step 306, after replacing cumulative residence time carried in the 1588 data packet with a sum of the cumulative residence time carried in the 1588 data packet plus the corrected residence time of the 1588 data packet in the intermediate node, the intermediate node transmits the 1588 data packet to the next node.

In an implementation, the step 303 and the step 306 may be performed simultaneously. The step 303 has the same 1588 data packet as the 1588 data packet transmitted to the next node described in the step 306, and the frequency offset of the intermediate node relative to the master clock and the replaced cumulative residence time are carried in the 1588 data packet.

After the step 306, if the next node of the intermediate node in the step 303 and the step 306 is also an intermediate node, then the next node is also executed according to the steps of the intermediate node recorded in the step 301 to the step 306, till the next node is a slave node, and the slave node performs step 307 as below.

Step 307, a slave node obtains, according to a local clock frequency of the slave node and an obtained clock frequency of a previous node, a frequency offset of the slave node relative to the previous node.

In this step, the slave node generates the signal having an auxiliary frequency, and obtains the frequency offset of the slave node relative to the previous node according to the local clock frequency of the slave node and the obtained clock frequency of the previous node. The following method is used to implement this step specifically.

Step 1, frequency mixing a signal having the local clock frequency of the slave node with the generated signal having the auxiliary frequency to obtain a signal having a first mixed frequency. f_{R} represents the local clock frequency of the current node, f₀ represents the generated auxiliary frequency, f₀=f_{R}×(1−½ⁿ), where n represents a positive integer greater than 0, and a value of n enables an offset of f₀ for a local clock frequency to be slightly greater than a frequency offset range allowed by Ethernet.

Step 2, obtaining a cycle count of the signal having the local clock frequency of the slave node within one clock cycle of the signal having the first mixed frequency. C₁ represents the cycle count of the signal having the local clock frequency of the slave node within one clock cycle of the signal having the first mixed frequency, C₁=2ⁿ, where n represents a positive integer greater than 0, and a value of n enables an offset of f₀ for the local clock frequency to be slightly greater than a frequency offset range allowed by Ethernet.

Step 3, frequency mixing the signal having the clock frequency of the previous node with the signal having the auxiliary frequency to obtain a signal having a second mixed frequency. f_{T} represents the clock frequency of the previous node.

Step 4, obtaining a cycle count of the signal having the local clock frequency of the slave node within one clock cycle of the signal having the second mixed frequency. C₂ represents the cycle count of the signal having the local clock frequency of the slave node within one clock cycle of the signal having the second mixed frequency, C₂=f_{R}/(f_{T}−f_{R}×(1−1/C1)).

Step 5, obtaining the frequency offset of the slave node relative to the previous node according to Δf(s)=(C₂−C₁)/(C₁C₂+C₁−C₂), where, s indicates the slave node, Δf(s) indicates the frequency offset of the slave node relative to the previous node, C₁ indicates the cycle count of the signal having the local clock frequency of the slave node within one clock cycle of the signal having the first mixed frequency, and C₂ indicates the cycle count of the signal having the local clock frequency of the slave node within one clock cycle of the signal having the second mixed frequency. Specifically, Δf(s)=(f_{R}−f_{T})/f_{T}=(C₂−C₁)/(C₁C₂+C₁−C₂).

The step 2 described above is performed after the step 1 is performed, the step 4 is performed after the step 3 is performed, the step 5 is performed after both the step 2 and the step 4 are performed, and the execution sequence is not limited between the step 1 as well as the step 2 and the step 3 as well as the step 4.

Moreover, after the step 1 and before the step 2, the first mixed frequency may also be subject to low-pass filtering, and in the step 2, the cycle count of the signal having the local clock frequency of the slave node within one clock cycle of the signal having the first mixed frequency after the low-pass filtering is obtained. After the step 3 and before the step 4, the second mixed frequency may also be subject to low-pass filtering, and in the step 4, the cycle count of the signal having the local clock frequency of the slave node within one clock cycle of the signal having the second mixed frequency after the low-pass filtering is obtained.

Step 308, the slave node obtains, according to the frequency offset of the slave node relative to the previous node and an obtained frequency offset of the previous node relative to a master clock, a frequency offset of the slave node relative to the master clock.

In this step, the frequency offset of the slave node relative to the master clock is obtained according to Δf_S(s)=(1+Δf_TC(i−1))(1+Δf(s))−1, where, s indicates the slave node, i−1 indicates a serial number of the previous node, Δf_S(s) indicates the frequency offset of the slave node relative to the master clock, Δf_TC(i−1) indicates the frequency offset of the previous node relative to the master clock, and Δf(s) indicates the frequency offset of the slave node relative to the previous node.

After the step 308, the step 309 is performed.

Step 309, the slave node corrects, according to the frequency offset of the slave node relative to the master clock, the clock frequency of the slave node.

In this step, the corrected clock frequency of the slave node is obtained via f_S′=f_S/(1+Δf_S(s)), where f_S′ is the corrected clock frequency of the slave node, f_S is the clock frequency of the slave node before the correction, and Δf_S(s) is the obtained frequency offset of the slave node relative to the master clock.

After the step 308, a step 310 as below may also be performed. The execution sequence of the step 309 and the step 310 is not limited, the step 310 may be performed at the time of performing the step 309, and may also be performed before or after performing the step 309.

Step 310, the slave node corrects time of the slave node according to time stamp information captured when receiving and transmitting the 1588 data packet and cumulative residence time carried in the 1588 data packet.

In this step, the slave node obtains the corrected time of the slave node according to a 1588 protocol algorithm through time indicated by time stamp information which is captured when receiving and transmitting the 1588 data packet and cumulative residence time carried in the 1588 data packet.

Based on the technical solutions described above, furthermore, an intermediate node may also update and maintain a frequency offset of the intermediate node relative to a master clock. In an implementation, if either a frequency offset value of a previous node relative to the master clock that is obtained by the intermediate node or a frequency offset of the intermediate node relative to the previous node that is measured locally changes, the intermediate node updates the frequency offset of the intermediate node relative to the master clock. Furthermore, when the frequency offset of the intermediate node relative to the master clock is updated, an updated frequency offset of the intermediate node relative to the master clock is transmitted to a next node.

In embodiment 3 of the present invention, any one of an intermediate node and a slave node obtains a frequency offset of itself relative to a previous node according to a local clock frequency of itself, a generated auxiliary frequency and an obtained clock frequency of the previous node, and then obtains a frequency offset of itself relative to a master clock according to the frequency offset of itself relative to the previous node and an obtained frequency offset of the previous node relative to the master clock, and the intermediate node transmits the frequency offset of itself relative to the master clock to a next node, so that the slave node can compute a frequency offset of the slave node relative to the master clock according to the frequency offset of the intermediate node relative to the master clock, and correct a clock frequency and time of the slave node according to the frequency offset of the slave node relative to the master clock. Since the frequency offsets of both the intermediate node and the slave node relative to the master clock are measured, thus the clock frequency of the slave node may be corrected, and frequency synchronization precision is improved. Moreover, residence time of a 1588 data packet in the intermediate node may also be corrected according the frequency offset of the intermediate node relative to the master clock, thus time synchronization precision may be improved when the time of the slave node is corrected.

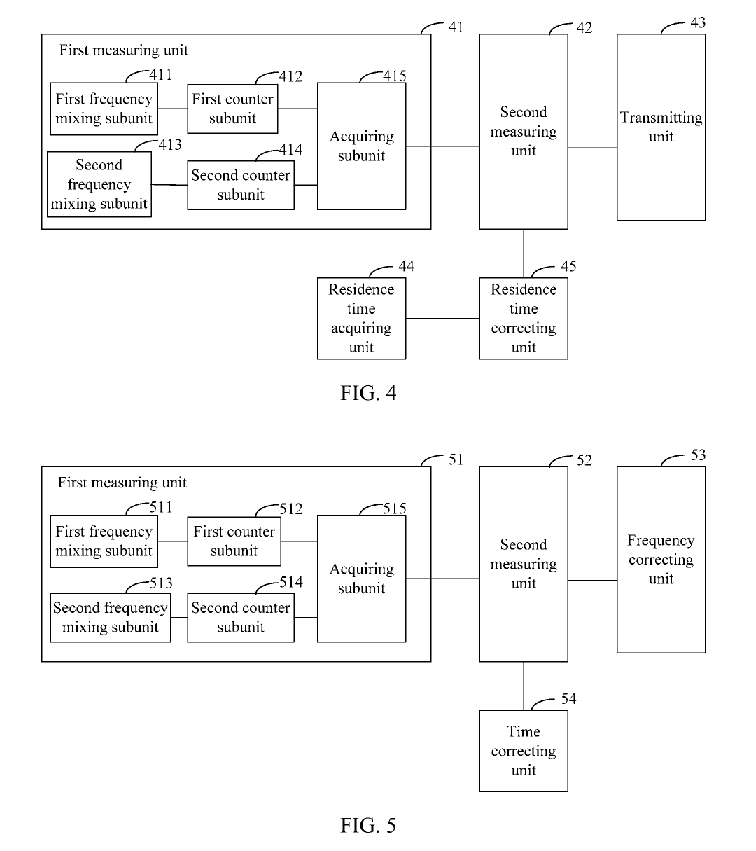

FIG. 4 is a schematic structural diagram of a synchronization apparatus of an intermediate node of a communication network system according to embodiment 4 of the present invention. As shown in FIG. 4, the apparatus at least includes: a first measuring unit 41, a second measuring unit 42 and a transmitting unit 43.

The first measuring unit 41 is configured to obtain, according to a local clock frequency of the intermediate node and an obtained clock frequency of a previous node, a frequency offset of the intermediate node relative to the previous node.

The second measuring unit 42 is configured to obtain, according to the frequency offset of the intermediate node relative to the previous node and an obtained frequency offset of the previous node relative to a master clock, a frequency offset of the intermediate node relative to the master clock.

The transmitting unit 43 is configured to transmit the frequency offset of the intermediate node relative to the master clock to a next node, so that a slave node corrects a clock frequency of the slave node or a clock frequency and time of the slave node according to the frequency offset of the intermediate node relative to the master clock.

Based on the technical solution described above, furthermore, the first measuring unit 41 may specifically include: a first frequency mixing subunit 411, a first counter subunit 412, a second frequency mixing subunit 413, a second counter subunit 414 and an acquiring subunit 415. The first frequency mixing subunit 411 is configured to frequency mix a signal having the local clock frequency of the current node with a generated signal having an auxiliary frequency to obtain a signal having a first mixed frequency. The first counter subunit 412 is configured to obtain a cycle count of the signal having the local clock frequency within one clock cycle of the signal having the first mixed frequency. The second frequency mixing subunit 413 is configured to frequency mix the signal having the clock frequency of the previous node with the signal having the auxiliary frequency to obtain a signal having a second mixed frequency. The second counter subunit 414 is configured to obtain a cycle count of the signal having the local clock frequency within one clock cycle of the signal having the second mixed frequency. The acquiring subunit 415 is configured to obtain the frequency offset of the intermediate node relative to the previous node according to Δf(i)=(C₂−C₁)/(C₁C₂+C₁−C₂), where, i indicates a serial number of the intermediate node, Δf(i) indicates the frequency offset of the intermediate node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

Based on the technical solutions described above, furthermore, the second measuring unit 42 is specifically configured to obtain the frequency offset of the intermediate node relative to the master clock according to Δf_TC(i)=(1+Δf_TC(i−1))(1+Δf(i))−1, where, i indicates a serial number of the intermediate node, i−1 indicates a serial number of the previous node, Δf_TC(i) indicates the frequency offset of the intermediate node relative to the master clock, Δf_TC(i−1) indicates the frequency offset of the previous node relative to the master clock, and Δf(i) indicates the frequency offset of the intermediate node relative to the previous node.

Based on the technical solutions described above, furthermore, the transmitting unit 43 is specifically configured to transmit a 1588 data packet to the next node, where the frequency offset of the intermediate node relative to the master clock is carried in a reserved field of a packet header of the 1588 data packet. Or, the transmitting unit 43 is specifically configured to transmit a preset message employing a preset type length value TLV to the next node, where the frequency offset of the intermediate node relative to the master clock is carried in the preset message.

Based on the technical solutions described above, furthermore, the apparatus may also include: a residence time acquiring unit 44 and a residence time correcting unit 45. The residence time acquiring unit 44 is configured to obtain residence time of the 1588 data packet in the intermediate node according to time stamp information captured when receiving and transmitting the 1588 data packet. The residence time correcting unit 45 is configured to correct the residence time of the 1588 data packet in the intermediate node by using the frequency offset of the intermediate node relative to the master clock. Correspondingly, the transmitting unit 43 is further configured to transmit the 1588 data packet to the next node after replacing cumulative residence time carried in the 1588 data packet with a sum of the cumulative residence time carried in the 1588 data packet plus the corrected residence time of the 1588 data packet in the intermediate node.

Based on the technical solutions described above, furthermore, the residence time correcting unit 45 is specifically configured to correct the residence time of the 1588 data packet in the intermediate node according to Δt_TC(i)=Δt(i)/(1+Δf_TC(i)), where, i indicates a serial number of the intermediate node, Δt_TC(i) indicates the corrected residence timer of the 1588 data packet in the intermediate node, Δt(i) indicates the obtained residence time of the 1588 data packet in the intermediate node according to time stamp information captured when receiving and transmitting the 1588 data packet, and Δf_TC(i) indicates the frequency offset of the intermediate node relative to the master clock.

The apparatus in embodiment 4 of the present invention may be configured to implement the synchronization method performed by the intermediate node in embodiment 1 of the present invention to embodiment 3 of the present invention, and reference may be made to embodiment 1 of the present invention to embodiment 3 of the present invention for a specific implementation and technical effects thereof, which will not be repeated herein.

FIG. 5 is a schematic structural diagram of a synchronization apparatus of a slave node of a communication network system according to embodiment 5 of the present invention. As shown in FIG. 5, the apparatus at least includes: a first measuring unit 51, a second measuring unit 52 and a frequency correcting unit 53.

The first measuring unit 51 is configured to obtain, according to a local clock frequency of the slave node and an obtained clock frequency of a previous node, a frequency offset of the slave node relative to the previous node.

The second measuring unit 52 is configured to obtain, according to the frequency offset of the slave node relative to the previous node and an obtained frequency offset of the previous node relative to a master clock, a frequency offset of the slave node relative to the master clock.

The frequency correcting unit 53 is configured to correct, according to the frequency offset of the slave node relative to the master clock, the clock frequency of the slave node.

Based on the technical solutions described above, furthermore, the first measuring unit 51 may specifically include: a first frequency mixing subunit 511, a first counter subunit 512, a second frequency mixing subunit 513, a second counter subunit 514 and an acquiring subunit 515. The first frequency mixing subunit 511 is configured to frequency mix a signal having the local clock frequency with a generated signal having an auxiliary frequency to obtain a signal having a first mixed frequency. The first counter subunit 512 is configured to obtain a cycle count of the signal having the local clock frequency within one clock cycle of the signal having the first mixed frequency. The second frequency mixing subunit 513 is configured to frequency mix the signal having the clock frequency of the previous node with the signal having the auxiliary frequency to obtain a signal having a second mixed frequency. The second counter subunit 514 is configured to obtain a cycle count of the signal having the local clock frequency within one clock cycle of the signal having the second mixed frequency. The acquiring subunit 515 is configured to obtain the frequency offset of the slave node relative to the previous node according to Δf(s)=(C₂−C₁)/(C₁C₂+C₁−C₂), where, s indicates the slave node, Δf(s) indicates the frequency offset of the slave node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

Based on the technical solutions described above, furthermore, the second measuring unit 52 is specifically configured to obtain the frequency offset of the slave node relative to the master clock according to Δf_S(s)=(1+Δf_TC(i−1))(1+Δf(s))−1, where, s indicates the slave node, i−1 indicates a serial number of the previous node, Δf_S(s) indicates the frequency offset of the slave node relative to the master clock, Δf_TC(i−1) indicates the frequency offset of the previous node relative to the master clock, and Δf(s) indicates the frequency offset of the slave node relative to the previous node.

Based on the technical solutions described above, furthermore, the apparatus may also include: a time correcting unit 54. The time correcting unit 54 is configured to correct time of the slave node according to time stamp information captured when receiving and transmitting a 1588 data packet and cumulative residence time carried in the 1588 data packet.

The apparatus in embodiment 5 of the present invention may be configured to implement the synchronization method performed by the slave node in embodiment 1 of the present invention to embodiment 3 of the present invention, and reference may be made to embodiment 1 of the present invention to embodiment 3 of the present invention for a specific implementation and technical effects thereof, which will not be repeated herein.

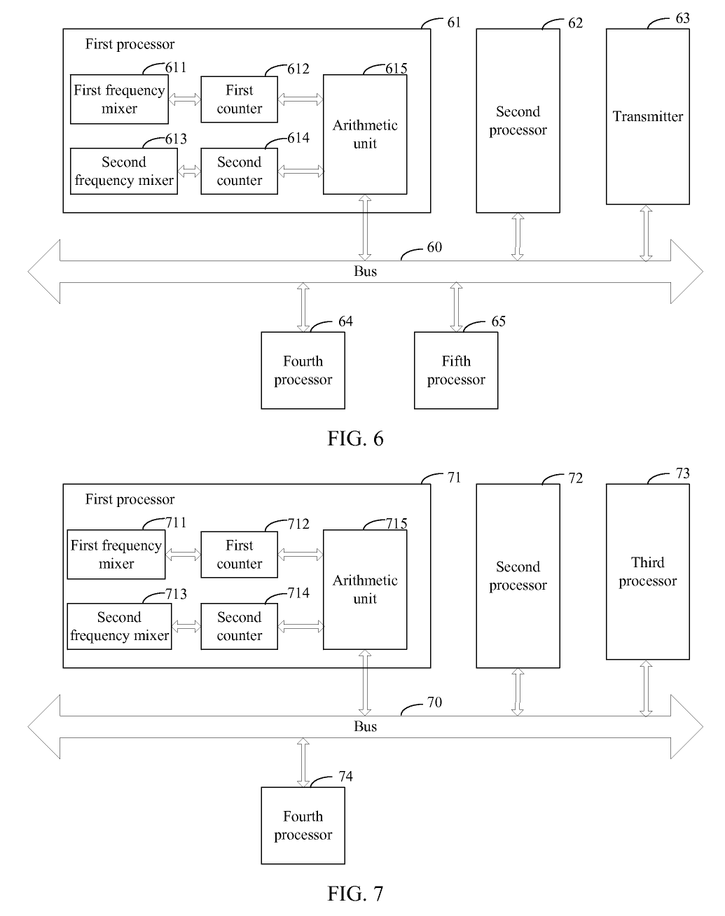

FIG. 6 is a schematic structural diagram of an intermediate node of a communication network system according to embodiment 6 of the present invention. As shown in FIG. 6, the intermediate node at least includes: a first processor 61, a second processor 62, a transmitter 63 and a bus 60.

The first processor 61 is configured to obtain, according to a local clock frequency of the intermediate node and an obtained clock frequency of a previous node, a frequency offset of the intermediate node relative to the previous node.

The second processor 62 is configured to obtain, according to the frequency offset of the intermediate node relative to the previous node and an obtained frequency offset of the previous node relative to a master clock, a frequency offset of the intermediate node relative to the master clock.

The transmitter 63 is configured to transmit the frequency offset of the intermediate node relative to the master clock to a next node, so that a slave node corrects a clock frequency of the slave node or a clock frequency and time of the slave node according to the frequency offset of the intermediate node relative to the master clock.

The bus 60 is configured to connect the first processor 61, the second processor 62 and the transmitter 63, where a data interaction is performed among the first processor 61, the second processor 62 and the transmitter 63 via the bus 60.

Based on the technical solutions described above, furthermore, the first processor 61 specifically includes: a first frequency mixer 611, a first counter 612, a second frequency mixer 613, a second counter 614 and an arithmetic unit 615.

The first frequency mixer 611 is configured to frequency mix a signal having the local clock frequency of the current node with a generated signal having an auxiliary frequency to obtain a signal having a first mixed frequency. The first counter 612 is configured to obtain a cycle count of the signal having the local clock frequency within one clock cycle of the signal having the first mixed frequency. The second frequency mixer 613 is configured to mix the signal having the clock frequency of the previous node with the signal having the auxiliary frequency to obtain a signal having a second mixed frequency. The second counter 614 is configured to obtain a cycle count of the signal having the local clock frequency within one clock cycle of the signal having the second mixed frequency. The arithmetic unit 615 is configured to obtain the frequency offset of the intermediate node relative to the previous node according to Δf(i)=(C₂−C₁)/(C₁C₂+C₁−C₂), where, i indicates a serial number of the intermediate node, Δf(i) indicates the frequency offset of the intermediate node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

Based on the technical solutions described above, furthermore, the second processor 62 is specifically configured to obtain the frequency offset of the intermediate node relative to the master clock according to Δf_TC(i)=(1+Δf_TC(i−1))(1+Δf(i))−1, where, i indicates a serial number of the intermediate node, i−1 indicates a serial number of the previous node, Δf_TC(i) indicates the frequency offset of the intermediate node relative to the master clock, Δf_TC(i−1) indicates the frequency offset of the previous node relative to the master clock, and Δf(i) indicates the frequency offset of the intermediate node relative to the previous node.

Based on the technical solutions described above, furthermore, the transmitter 63 is specifically configured to transmit a 1588 data packet to the next node, where the frequency offset of the intermediate node relative to the master clock is carried in a reserved field of a packet header of the 1588 data packet. Or, the transmitter 63 is specifically configured to transmit a preset message employing a preset type length value TLV to the next node, where the frequency offset of the intermediate node relative to the master clock is carried in the preset message.

Based on the technical solutions described above, furthermore, the intermediate node may also include: a fourth processor 64 and a fifth processor 65. The fourth processor 64 is configured to obtain residence time of the 1588 data packet in the intermediate node according to time stamp information captured when receiving and transmitting the 1588 data packet. The fifth processor 65 is configured to correct the residence time of the 1588 data packet in the intermediate node by using the frequency offset of the intermediate node relative to the master clock. Correspondingly, the transmitter is further configured to transmit the 1588 data packet to the next node after replacing cumulative residence time carried in the 1588 data packet with a sum of the cumulative residence time carried in the 1588 data packet plus the corrected residence time of the 1588 data packet in the intermediate node.

Based on the technical solutions described above, furthermore, the fifth processor 65 is specifically configured to correct the residence time of the 1588 data packet in the intermediate node according to Δt_TC(i)=Δt(i)/(1+Δf_TC(i)), where, i indicates a serial number of the intermediate node, Δt_TC(i) indicates the corrected residence timer of the 1588 data packet in the intermediate node, Δt(i) indicates the obtained residence time of the 1588 data packet in the intermediate node according to time stamp information captured when receiving and transmitting the 1588 data packet, and Δf_TC(i) indicates the frequency offset of the intermediate node relative to the master clock.

The intermediate node in embodiment 6 of the present invention may be used to implement the synchronization method performed by the intermediate node in embodiment 1 of the present invention to embodiment 3 of the present invention, and reference may be made to embodiment 1 of the present invention to embodiment 3 of the present invention for a specific implementation and technical effects thereof, which will not be repeated herein. In addition, the above mentioned processors can be implemented by one processor, which may carry out all functions of these processors.

FIG. 7 is a schematic structural diagram of a slave node of a communication network system according to embodiment 7 of the present invention. As shown in FIG. 7, the slave node at least includes: a first processor 71, a second processor 72, a third processor 73 and a bus 70.

The first processor 71 is configured to obtain, according to a local clock frequency of the slave node and an obtained clock frequency of a previous node, a frequency offset of the slave node relative to the previous node.

The second processor 72 is configured to obtain, according to the frequency offset of the slave node relative to the previous node and an obtained frequency offset of the previous node relative to a master clock, a frequency offset of the slave node relative to the master clock.

The third processor 73 is configured to correct, according to the frequency offset of the slave node relative to the master clock, the clock frequency of the slave node.

The bus 70 is configured to connect the first processor 71, the second processor 72 and the third processor 73, where a data interaction is performed among the first processor 71, the second process 72 and the third processor 73 via the bus 70.

Based on the technical solutions described above, furthermore, the first processor 71 may specifically include: a first frequency mixer 711, a first counter 712, a second frequency mixer 713, a second counter 714 and an arithmetic unit 715. The first frequency mixer 711 is configured to frequency mix a signal having the local clock frequency with a generated signal having an auxiliary frequency to obtain a signal having a first mixed frequency. The first counter 712 is configured to obtain a cycle count of the signal having the local clock frequency within one clock cycle of the signal having the first mixed frequency. The second frequency mixer 713 is configured to frequency mix the signal having the clock frequency of the previous node with the signal having the auxiliary frequency to obtain a signal having a second mixed frequency. The second counter 714 is configured to obtain a cycle count of the signal having the local clock frequency within one clock cycle of the signal having the second mixed frequency. The arithmetic unit 715 is configured to obtain the frequency offset of the slave node relative to the previous node according to Δf(s)=(C₂−C₁)/(C₁C₂+C₁−C₂), where, s indicates the slave node, Δf(s) indicates the frequency offset of the slave node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

Based on the technical solutions described above, furthermore, the second processor 72 is specifically configured to obtain the frequency offset of the slave node relative to the master clock according to Δf_S(s)=(1+Δf_TC(i−1))(1+Δf(s))−1, where, s indicates the slave node, i−1 indicates a serial number of the previous node, Δf_S(s) indicates the frequency offset of the slave node relative to the master clock, Δf_TC(i−1) indicates the frequency offset of the previous node relative to the master clock, and Δf(s) indicates the frequency offset of the slave node relative to the previous node.

Based on the technical solutions described above, furthermore, the slave node may also include: a fourth processor 74. The fourth processor 74 is configured to correct, time of the slave node according to time stamp information captured when receiving and transmitting a 1588 data packet and cumulative residence time carried in the 1588 data packet.

The slave node in embodiment 7 of the present invention may be used to implement the synchronization method performed by the slave node in embodiment 1 of the present invention to embodiment 3 of the present invention, and reference may be made to embodiment 1 of the present invention to embodiment 3 of the present invention for a specific implementation and technical effects thereof, which will not be repeated herein. In addition, the above mentioned processors can be implemented by one processor, which may carry out all functions of these processors.

In the embodiments of the present invention described above, a frequency offset of a current node relative to a previous node is measured by generating an auxiliary frequency. In other implementations, the frequency offset of the current node relative to the previous node may also be measured in other manners, for instance, a signal is performed by methods such as a direct cycle count, a frequency discrimination and a phase discrimination within a period of time.

It should be noted that, for a brief description, the forgoing method embodiments are expressed as a series of action combinations; however, a person skilled in the art should know that the present invention is not limited to the described action sequence because some steps may be performed in other sequences or performed at the same time according to the present invention. Secondly, a person of ordinary skill in the art should also know that, the embodiments described in the specification are preferred embodiments, and the involved actions and modules are not indispensable parts of the present invention.

In the foregoing embodiments, each embodiment is described with a different emphasis; and for the part not elaborated in an embodiment, reference may be made to related descriptions in other embodiments.

Persons of ordinary skill in the art may understand that, all or a part of steps of the foregoing method embodiments may be implemented by a program instructing relevant hardware. The foregoing program may be stored in a computer readable storage medium. When the program runs, the steps of the foregoing method embodiments are performed. The foregoing storage medium includes various mediums capable of storing program codes, such as an ROM, an RAM, a magnetic disk, or an optical disc.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some or all technical features therein; however, these modifications or replacements do not make the essence of corresponding technical solutions depart from the scope of the technical solutions in the embodiments of the present invention.

What is claimed is:

1. A synchronization method of a communication network system, comprising:
obtaining, by an intermediate node, according to a local clock frequency of the intermediate node and an obtained clock frequency of a previous node, a frequency offset of the intermediate node relative to the previous node;
obtaining, by the intermediate node, according to the frequency offset of the intermediate node relative to the previous node and an obtained frequency offset of the previous node relative to a master clock, a frequency offset of the intermediate node relative to the master clock; and
transmitting, by the intermediate node, the frequency offset of the intermediate node relative to the master clock to a next node, so that a slave node corrects a clock frequency of the slave node or a clock frequency and time of the slave node according to the frequency offset of the intermediate node relative to the master clock.

2. The method according to claim 1, wherein, the obtaining, by the intermediate node, according to the local clock frequency of the intermediate node and the obtained clock frequency of the previous node, the frequency offset of the intermediate node relative to the previous node comprises:
frequency mixing a signal having the local clock frequency with a generated signal having an auxiliary frequency to obtain a signal having a first mixed frequency;
obtaining a cycle count of the signal having the local clock frequency within one clock cycle of the signal having the first mixed frequency;
frequency mixing the signal having the clock frequency of the previous node with the signal having the auxiliary frequency to obtain a signal having a second mixed frequency;
obtaining a cycle count of the signal having the local clock frequency within one clock cycle of the signal having the second mixed frequency; and
obtaining the frequency offset of the intermediate node relative to the previous node according to Δf(i)=(C₂−C₁)/(C₁C₂+C₁−C₂), wherein, i indicates a serial number of the intermediate node, Δf(i) indicates the frequency offset of the intermediate node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

3. The method according to claim 1, the obtaining, by the intermediate node, according to the frequency offset of the intermediate node relative to the previous node and the obtained frequency offset of the previous node relative to the master clock, the frequency offset of the intermediate node relative to the master clock comprises:
obtaining the frequency offset of the intermediate node relative to the master clock according to Δf_TC(i)=(1+Δf_TC(i−1))(1+Δf(i))−1, wherein, i indicates a serial number of the intermediate node, i−1 indicates a serial number of the previous node, Δf_TC(i) indicates the frequency offset of the intermediate node relative to the master clock, Δf_TC(i−1) indicates the frequency offset of the previous node relative to the master clock, and Δf(i) indicates the frequency offset of the intermediate node relative to the previous node.

4. The method according to claim 1, wherein, the transmitting the frequency offset of the intermediate node relative to the master clock to the next node comprises:
transmitting a 1588 data packet to the next node, wherein the frequency offset of the intermediate node relative to the master clock is carried in a reserved field of a packet header of the 1588 data packet; or
transmitting a preset message employing a preset type length value TLV to the next node, wherein the frequency offset of the intermediate node relative to the master clock is carried in the preset message.

5. The method according to claim 1, wherein, after the obtaining the frequency offset of the intermediate node relative to the master clock, the method further comprises:
obtaining, by the intermediate node, residence time of the 1588 data packet in the intermediate node according to time stamp information captured when receiving and transmitting the 1588 data packet;
correcting, by the intermediate node, the residence time of the 1588 data packet in the intermediate node by using the frequency offset of the intermediate node relative to the master clock; and
transmitting, by the intermediate node, the 1588 data packet to the next node after replacing cumulative residence time carried in the 1588 data packet with a sum of the cumulative residence time carried in the 1588 data packet plus the corrected residence time of the 1588 data packet in the intermediate node.

6. The method according to claim 5, wherein the correcting, by the intermediate node, the residence time of the 1588 data packet in the intermediate node by using the frequency offset of the intermediate node relative to the master clock comprises:
correcting the residence time of the 1588 data packet in the intermediate node according to Δt_TC(i)=Δt(i)/(1+Δf_TC(i), wherein, i indicates a serial number of the intermediate node, Δt_TC(i) indicates the corrected residence timer of the 1588 data packet in the intermediate node, Δt(i) indicates the obtained residence time of the 1588 data packet in the intermediate node according to time stamp information captured when receiving and transmitting the 1588 data packet, and Δf_TC(i) indicates the frequency offset of the intermediate node relative to the master clock.

7. A synchronization method of a communication network system, comprising:
obtaining, by a slave node, according to a local clock frequency of the slave node and an obtained clock frequency of a previous node, a frequency offset of the slave node relative to the previous node;
obtaining, by the slave node, according to the frequency offset of the slave node relative to the previous node and an obtained frequency offset of the previous node relative to a master clock, a frequency offset of the slave node relative to the master clock; and
correcting, by the slave node, according to the frequency offset of the slave node relative to the master clock, the clock frequency of the slave node.

8. The method according to claim 7, wherein, the obtaining, by the slave node, according to the local clock frequency of the slave node and the obtained clock frequency of the previous node, the frequency offset of the slave node relative to the previous node comprises:
frequency mixing a signal having the local clock frequency with a generated signal having an auxiliary frequency to obtain a signal having a first mixed frequency;
obtaining a cycle count of the signal having the local clock frequency within one clock cycle of the signal having the first mixed frequency;
frequency mixing the signal having the clock frequency of the previous node with the signal having the auxiliary frequency to obtain a signal having a second mixed frequency;
obtaining a cycle count of the signal having the local clock frequency within one clock cycle of the signal having the second mixed frequency; and
obtaining the frequency offset of the slave node relative to the previous node according to Δf(s)=(C₂−C₁)/(C₁C₂+C₁−C₂), wherein, s indicates the slave node, Δf(s) indicates the frequency offset of the slave node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

9. The method according to claim 7, wherein, the obtaining, according to the frequency offset of the slave node relative to the previous node and the obtained frequency offset of the previous node relative to the master clock, the frequency offset of the slave node relative to the master clock comprises:
obtaining the frequency offset of the slave node relative to the master clock according to Δf_S(s)=(1+Δf_TC(i−1))(1+Δf(s))−1, wherein, s indicates the slave node, i−1 indicates a serial number of the previous node, Δf_S(s) indicates the frequency offset of the slave node relative to the master clock, Δf_TC(i−1) indicates the frequency offset of the previous node relative to the master clock, and Δf(s) indicates the frequency offset of the slave node relative to the previous node.

10. The method according to claim 7, wherein, after the obtaining the frequency offset of the slave node relative to the master clock, the method further comprises:
correcting, by the slave node, time of the slave node according to time stamp information captured when receiving and transmitting a 1588 data packet and cumulative residence time carried in the 1588 data packet.

11. An intermediate node of a communication network system, comprising:
a first processor, configured to obtain, according to a local clock frequency of the intermediate node and an obtained clock frequency of a previous node, a frequency offset of the intermediate node relative to the previous node;
a second processor, configured to obtain, according to the frequency offset of the intermediate node relative to the previous node and an obtained frequency offset of the previous node relative to a master clock, a frequency offset of the intermediate node relative to the master clock;
a transmitter, configured to transmit the frequency offset of the intermediate node relative to the master clock to a next node, so that a slave node corrects a clock frequency of the slave node or a clock frequency and time of the slave node according to the frequency offset of the intermediate node relative to the master clock; and
a bus, configured to connect the first processor, the second processor and the transmitter, wherein an information or data interaction is performed among the first processor, the second processor and the transmitter via the bus.

12. The intermediate node according to claim 11, wherein, the first processor specifically comprises:
a first frequency mixer, configured to frequency mix a signal having the local clock frequency of the current node with a generated signal having an auxiliary frequency to obtain a signal having a first mixed frequency;
a first counter, configured to obtain a cycle count of the signal having the local clock frequency within one clock cycle of the signal having the first mixed frequency;
a second frequency mixer, configured to frequency mix the signal having the clock frequency of the previous node with the signal having the auxiliary frequency to obtain a signal having a second mixed frequency;
a second counter, configured to obtain a cycle count of the signal having the local clock frequency within one clock cycle of the signal having the second mixed frequency; and
an arithmetic unit, configured to obtain the frequency offset of the intermediate node relative to the previous node according to Δf(i)=(C₂−C₁)/(C₁C₂+C₁−C₂), wherein, i indicates a serial number of the intermediate node, Δf(i) indicates the frequency offset of the intermediate node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

13. The intermediate node according to claim 11, wherein,
the second processor is specifically configured to obtain the frequency offset of the intermediate node relative to the master clock according to Δf_TC(i)=(1+Δf_TC(i−1))(1+Δf/(i))−1, wherein, i indicates a serial number of the intermediate node, i−1 indicates a serial number of the previous node, Δf_TC(i) indicates the frequency offset of the intermediate node relative to the master clock, Δf_TC(i−1) indicates the frequency offset of the previous node relative to the master clock, and Δf(i) indicates the frequency offset of the intermediate node relative to the previous node.

14. The intermediate node according to claim 11, wherein,
the transmitter is specifically configured to transmit a 1588 data packet to the next node, wherein the frequency offset of the intermediate node relative to the master clock is carried in a reserved field of a packet header of the 1588 data packet; or
the transmitter is specifically configured to transmit a preset message employing a preset type length value TLV to the next node, wherein the frequency offset of the intermediate node relative to the master clock is carried in the preset message.

15. The intermediate node according to claim 11, wherein, the intermediate node further comprises:
a fourth processor, configured to obtain residence time of the 1588 data packet in the intermediate node according to time stamp information captured when receiving and transmitting the 1588 data packet;
a fifth processor, configured to correct the residence time of the 1588 data packet in the intermediate node by using the frequency offset of the intermediate node relative to the master clock; and
the transmitter is further configured to transmit the 1588 data packet to the next node after replacing cumulative residence time carried in the 1588 data packet with a sum of the cumulative residence time carried in the 1588 data packet plus the corrected residence time of the 1588 data packet in the intermediate node.

16. The intermediate node according to claim 15, wherein,
the fifth processor is specifically configured to correct the residence time of the 1588 data packet in the intermediate node according to Δt_TC(i)=Δt(i)/(1+Δf_TC(i)), wherein, i indicates a serial number of the intermediate node, Δt_TC(i) indicates the corrected residence timer of the 1588 data packet in the intermediate node, Δt(i) indicates the obtained residence time of the 1588 data packet in the intermediate node according to time stamp information captured when receiving and transmitting the 1588 data packet, and Δf_TC(i) indicates the frequency offset of the intermediate node relative to the master clock.

17. A slave node of a communication network system, comprising:
a first processor, configured to obtain, according to a local clock frequency of the slave node and an obtained clock frequency of a previous node, a frequency offset of the slave node relative to the previous node;
a second processor, configured to obtain, according to the frequency offset of the slave node relative to the previous node and an obtained frequency offset of the previous node relative to a master clock, a frequency offset of the slave node relative to the master clock;
a third processor, configured to correct, according to the frequency offset of the slave node relative to the master clock, the clock frequency of the slave node; and
a bus, configured to connect the first processor, the second processor and the third processor, wherein a data interaction is performed among the first processor, the second process and the third processor via the bus.

18. The slave node according to claim 17, wherein, the first processor specifically comprises:
a first frequency mixer, configured to frequency mix a signal having the local clock frequency with a generated signal having an auxiliary frequency to obtain a signal having a first mixed frequency;
a first counter, configured to obtain a cycle count of the signal having the local clock frequency within one clock cycle of the signal having the first mixed frequency;
a second frequency mixer, configured to frequency mix the signal having the clock frequency of the previous node with the signal having the auxiliary frequency to obtain a signal having a second mixed frequency;
a second counter, configured to obtain a cycle count of the signal having the local clock frequency within one clock cycle of the signal having the second mixed frequency; and
an arithmetic unit, configured to obtain the frequency offset of the slave node relative to the previous node according to Δf(s)=(C₂−C₁)/(C₁C₂+C₁−C₂), wherein, s indicates the slave node, Δf(s) indicates the frequency offset of the slave node relative to the previous node, C₁ indicates the cycle count of the signal having the local clock frequency within one clock cycle of the signal having the first mixed frequency, and C₂ indicates the cycle count of the signal having the local clock frequency within one clock cycle of the signal having the second mixed frequency.

19. The slave node according to claim 17, wherein,
the second processor is specifically configured to obtain the frequency offset of the slave node relative to the master clock according to Δf_S(s)=(1+Δf_TC(i−1))(1+Δf(s))−1, wherein, s indicates the slave node, i−1 indicates a serial number of the previous node, Δf_S(s) indicates the frequency offset of the slave node relative to the master clock, Δf_TC(i−1) indicates the frequency offset of the previous node relative to the master clock, and Δf(s) indicates the frequency offset of the slave node relative to the previous node.

20. The slave node according to claim 17, wherein, the slave node further comprises:
a fourth processor, configured to correct time of the slave node according to time stamp information captured when receiving and transmitting a 1588 data packet and cumulative residence time carried in the 1588 data packet.
